(19) United States
(12) Patent Application Publication
(10) Pub. No.: US 2007/0061341 A1
(43) Pub. Date: Mar. 15, 2007

(54) System and method for storing and/or accessing data

(76) Inventors: Jahangir S. Rastegar, Stony Brook, NY (US); Thomas Spinelli, East Northport, NY (US)

Correspondence Address: Thomas Spinelli, 2 Sipala Court, East Northport, NY, 11731, US

(21) Appl. No.: 11/520,320

(22) Filed: Sep. 13, 2006

Related U.S. Application Data
(60) Provisional application No. 60/716,697, filed on Sep. 13, 2005.

(51) Int. Cl. G06F 17/30

(52) U.S. Cl. 707/10

(57) ABSTRACT

A method for storing form data is provided. The method including: displaying a form at an internet or intranet web site; allowing a user to enter data into the form; saving the data entered by the user; and indicating a date that the data was entered.

### CROSS REFERENCE TO RELATED APPLICATION

This application claims benefit to U.S. Provisional Application Ser. No. 60/716,697 filed Sep. 13, 2005, the entire contents of which is incorporated herein by reference.

### BACKGROUND OF THE INVENTION

1. Field of the Invention

The present invention relates generally to storing and/or accessing data remotely and, more particularly, to storing and/or accessing data, such as invention disclosures and conceptions, remotely, such as over a network, such as the Internet.

2. Prior Art

Data is necessarily stored and/or accessed in every form of business and in non-business situations. Such data is sometimes in the form of a template. Templates are filled out in almost every art and industry and serve a purpose therein. For example, in the scientific world, scientist keep records of their work, usually in the form of a laboratory notebook, or other form of diary which chronicles their work and conceptions. Such diaries have numbered pages and are often signed by witnesses and dated as evidentiary proof of the conception of an invention. They may also be notarized by a notary public. Such diaries usually are kept by the individual scientist. Therefore, the practices for keeping such records and for witnessing and notarizing any entries therein vary between scientists.

The scientific world also uses invention disclosure forms for scientists to describe and/or illustrate an invention, which the scientist would like to be considered for patent protection. Such a template may have several questions regarding the invention as well as spaces for a description of the invention. Such templates vary from company to company and from department to department within the same company. Such invention disclosures can also serve as evidentiary proof of a conception and/or aid in a showing of diligence in reducing the invention to practice after conception.

Data is also stored and /or accessed without the use of a template or only partially with a template. For example, an inventor may describe an invention using text and figures in no particular format. However, such a description may also serve as evidentiary proof of a first conception of the invention and/or aid in a showing of diligence in reducing the invention to practice after conception.

Such templates and descriptions are often hard copies which are scuttled about a company before being witnessed or received by an appropriate company official or employee thereby lengthening the time the invention is filed as a patent application and/or not getting an earliest date of conception as is merited. The evidentiary value to such paper copies is often disputed and invalidated because they are self serving and often do not have proper signatures and/or dates or because the witnesses are often biased in some way, further decreasing the evidentiary value of the same.

### SUMMARY OF THE INVENTION

Accordingly, a method for storing form data is provided. The method comprising: displaying a form at an internet or intranet web site; allowing a user to enter data into the form; saving the data entered by the user; and indicating a date that the data was entered.

The method can further comprise allowing access to the saved data in a read-only format.

The displaying can comprise allowing the user to select a form appropriate for the type of data to be entered. The displaying can further comprise allowing the user to select a form appropriate to a particular jurisdiction.

The method can further comprise allowing one or more witnesses to digitally sign the entered data.

The indicating can comprise saving the data with a header indicating at least one of time and date that the data was entered.

The data can be saved in a series of documents with varying degrees of completeness.

The data can be encrypted prior to the saving.

The method can further comprise permitting third parties to view the stored data.

The method can further comprise confirming the saving of the data.

Also provided are a computer program product for carrying out the methods of the present invention and a program storage device for the storage of the computer program product therein.

### DETAILED DESCRIPTION OF THE PREFERRED EMBODIMENT

Although the present invention is applicable to numerous types of data and remote networks, it is particularly useful in the environment of form data, such as invention disclosure and conception forms and Internet and Intranet networks. Therefore, without limiting the applicability of the present invention to such form data and remote networks, it will be described in such environment.

A business method is provided for safekeeping and date/time of deposit logging of information in general, and proprietary information in particular. Other information such as legal documents, copies of valuable information or documents, as well as those for safekeeping such as family pictures, letters, etc., kids drawings, pictures, writings, school work, etc., may also be stored.

The user may deposit information that is in its final form or may deposit drafts, as the final version is developed, by depositing newer versions of the information, additions/modifications, results of experiments, developed details, etc., and log them as such.

The information to be stored may be in writing, visual (pictures, movies, video, computer generated models such as solid models, drawings, manufacturing machinery codes and instructions), or it may be audio data such as songs, melodies, etc.

The following is an exemplary list of the types of data that can be stored, the types of data that can be stored include patent disclosure documents, log-book data (generated on a computer or scanned or other wise digitized), patent ideas, industrial and the like designs, technology know-how, software (software code, algorithms, flowcharts and the like), research (preliminary results, concepts, discoveries, hypothesis, articles-prior to publication, abstracts, new research areas, proposed work, and the like), written works (plots, manuscripts, plays and the like), music (songs, written music, rhythm and the like), paintings and other artistic works (sketches, pictures of paintings, and the like, pictures, sculptures, trademarks, legal documents (such as wills, living-wills, agreements, contracts, minutes of meetings, partnership agreements, deeds, evidence and the like).

The data is stored at a web site having a particular URL address. The web site includes a form for entering the data and can allow the user to attach a downloaded file representing one or more of the data types discussed above such that the downloaded data is connected to the form. The website can have a form corresponding to each of a plurality of generic data types, such as a specific form for a patent disclosure, or a legal document. Such a list can be provided in a drop down menu. Where the documents have certain legal requirements that may vary by jurisdiction (country, state, municipality etc.) the interface may provide additional choices for selecting a form for the appropriate jurisdiction, which may also be accomplished by a drop down list. Where a signature is required, such as by a witness necessary for laboratory notebook pages or a will, the witness(es) can provide a digital signature, as is known in the art. The website can be accessed, the data entered and the attachments, if any, attached by way of any number of means known in the art. For example, the same can be accomplished at a personal computer, laptop or using any other type of electronic device capable of accessing the internet and imputing data. Of course, the website may also be an intranet site that is only accessible by a certain community of users, e.g., a particular company, and not to the general public. Each user may be provided with their own depository that is only accessible by that user (or group of users, such as a company). The user (or group of users) gains access to their depository by use of a password or other means known in the art for restricting access.

When the form and any attached data is finished, the same is saved with information identifying the user and the time and date of “deposit.” Such information can be secured and not capable of manipulation or attack. For agreements, contracts, memorandum of understanding, letters of intent, letters of offers, etc., between more than one party, the document may be deposited in every party's depository at the same time and logged as such.

The information deposited can be digital, and may be encrypted by the user and stored in any available format. The user may choose to be the only holder of the encryption key. The user, for example, an organization, may assign a master key and separate keys to individual users. Alternatively, one or more encryption keys may be required by the user and one or more by the depository center in order to be able to decode the information.

The documents can be read only with no possibility of modification and can be certified as such by the depository center. The user may choose to store data with “deposit only” option, in which case, the data will be stored on storage devices with one way communication only, i.e., on devices with no link for reading.

The date/time of the deposit is preferably also made part of the document, such as with a cover page and an end page, to make it impossible to change or in a digital header.

The depository center stores duplicates at several locations, and in different forms, such as in the forms that are permanent without the possibility of modification, and when desired by the user, in printed form.

Before sending out a certified copy of a document, its content is checked against the permanent copies to ensure that they are identical or both (or more stored) copies will be certified and provided to the user, courts, etc.

The user may request that the depository center provide copies in any desired storage medium commonly used. This service ensures that valuable electronic information is easily accessible even when the storage medium becomes outdated.

The depository center may choose to change over the storage media and update file format to ensure that it is always readable by the user and that it stays current. The depository center internet or intranet web site can provide standard forms and instructions (for example forms and instructions for submitting an invention disclosure or laboratory notebook results (which can be made as often as necessary)); sample filled up forms and applications; a help menu for definitions or instructions; suggested reference material; related government or organization sites, and any other helpful information. Some of the above information may be restricted to the subscribers.

The internet or intranet web site can provide advertisement for various services (e.g., patent lawyer firms and expertise, legal council, investment bankers, venture capital firms, etc.) and provide links to the appropriate sites.

A particular database (e.g., patent disclosures) can be established and made available to certain third parties for review only (e.g., to advertise their technology for potential sale or licensing which is particularly useful for universities, national and government laboratories, not for profit organizations, individual inventors etc.) and provide links to appropriate web sites. A database can also be established for various people and firms and organizations to list their information and basic services for a fee (which may be waived for subscribers).

An authorized agent(s) of the subscriber can set up separate sub-accounts for each unit or personnel within the organization, who may be authorized to access one or more sub-accounts or the main account site. The individual sub-account holder may only be authorized to deposit data and prevented from retrieving any information. As discussed above, one or more other individuals (e.g., supervisors) can be capable of verifying the submission of a document (e.g., a patent disclosure) as witnesses.

The submission of a document can be automatically confirmed (e.g., by mail, facsimile, or e-mail), which includes an identification tag, after it has been stored on a storage device. The subscriber may also request confirmation in writing. The depository center firm may provide a service for subscribers to submit general questions about patents, trademarks, copyrights, and other proprietary rights information and laws.

Companies, firms, institutions, universities, government laboratories, and other organizations as well as individuals, groups of individuals, etc., may subscribe to the present service for a fee which may be for any agreed upon period of time and for any combination of services. The subscriber may also choose a basic plan, which will provide certain amount of storage and minimal additional services, and pay for additional services as one-time service fee.

When a subscriber reaches or is about to reach its quota, a warning can be sent to the subscriber. The subscriber can then choose to either eliminate some of the stored data or add storage capacity.

The depository center firm can set up an internet or intranet web site, which can be accessed by the general public, and provide information about the firm and its services. The subscriber can then login into a secure account, which will then be provided with the tools to deposit information or retrieve previously deposited information or request an available service.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for storing form data, the method comprising:
displaying a form at an internet or intranet web site;
allowing a user to enter data into the form;
saving the data entered by the user; and
indicating a date that the data was entered.

2. The method of claim 1, further comprising allowing access to the saved data in a read-only format.

3. The method of claim 1, wherein the displaying comprises allowing the user to select a form appropriate for the type of data to be entered.

4. The method of claim 3, wherein the displaying further comprises allowing the user to select a form appropriate to a particular jurisdiction.

5. The method of claim 1, further comprising allowing one or more witnesses to digitally sign the entered data.

6. The method of claim 1, wherein the indicating comprises saving the data with a header indicating at least one of time and date that the data was entered.

7. The method of claim 1, wherein the data is saved in a series of documents with varying degrees of completeness.

8. The method of claim 1, wherein the data is encrypted prior to the saving.

9. The method of claim 1, further comprising permitting third parties to view the stored data.

10. The method of claim 1, further comprising confirming the saving of the data.

11. A computer program product embodied in a computer-readable medium for storing form data, the computer program product comprising:
computer readable program code means for displaying a form at an internet or intranet web site;
computer readable program code means for allowing a user to enter data into the form;
computer readable program code means for saving the data entered by the user; and
computer readable program code means for indicating a date that the data was entered.

12. A program storage device readable by machine, tangibly embodying a program of instructions executable by the machine to perform method steps for storing form data, the method comprising:
displaying a form at an internet or intranet web site;
allowing a user to enter data into the form;
saving the data entered by the user; and
indicating a date that the data was entered.
